(19) United States
(12) Patent Application Publication
(10) Pub. No.: US 2010/0137005 A1
(43) Pub. Date: Jun. 3, 2010

(54) METHOD FOR POSITIONING PORTABLE COMMUNICATION DEVICE

(75) Inventors: Lei ZENG, NANJING (CN); Da-Wei ZHANG, NANJING (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/325,144

(22) Filed: Nov. 29, 2008

(51) Int. Cl. H04W 4/02

(52) U.S. Cl. 455/456.6

(57) ABSTRACT

A method for positioning a portable communication device is provided. First, the signal intensities of a plurality of base stations near the portable communication device receiving radio waves from the base stations are detected, and coordinates of the base stations are found in order to calculate a position coordinate of the portable communication device through the coordinates and the signal intensities of the base stations. Then, the values of a plurality of environmental features between at least one of the base stations and the portable communication device are obtained from a geographic information system (GIS) according to at least one coordinate of the base stations and the position coordinate of the portable communication device. After that, the signal intensities of the base stations are modified by substituting the values of the environmental features into a path loss model. Finally, the position coordinate of the portable communication device is recalculated according to the modified signal intensities of the base stations thereby enhancing the positioning accuracy substantially.

### FIELD OF THE INVENTION

The present invention relates to a positioning method, particularly to a method for calculating the position coordinate of a portable communication device through modifying the signal intensities received by the portable communication device.

### BACKGROUND OF THE INVENTION

Location based service (LBS) is typically utilized to identify a user's location information, e.g. longitude and latitude or geographic environment of local street, which may be provided to the user, the communication system provider (for fee calculation) or other organizations or people that need the location information. Because the method of positioning a portable device by itself has the advantages of low cost, high accuracy and being easily spread, LBS for portable device, which is widely applied in emergency rescue, car guidance, intelligent traffic management, team management and so forth, has become one of the most attention-getting techniques.

In general, if the error introduced by the propagation environment is not considered, conventional positioning algorithms such as least-squares method used in portable devices may meet general requirement. However, the accuracy of conventional positioning algorithms is not acceptable for high-accuracy positioning applications wherein the error introduced by the propagation environment cannot be ignored. Therefore, wave propagation models (such as Okumura-Hata model or Cost-231 model) are typically utilized to increase the positioning accuracy. The Cost-231 model may be expressed as the following formula

L=42.6+26 log(d)+20 log(f)

wherein d represents the distance between a portable device and a base station, L represents the signal intensity of the base station detected by the portable device, and f represents the base station's transmit frequency. As is understood from the above formula, the distance between the portable device and the base station can be calculated by substituting the signal intensity and the base station's transmit frequency into the above equation. Therefore, the position coordinate of the portable device can be calculated according to the distances between the portable device and at least three of the base stations as well as the coordinates of the base stations.

However, since the signal intensities may be affected by many factors such as the terrain features, the building intensity and the materials of the buildings around the portable device, the electromagnetic wave propagation model mentioned above cannot meet the actual condition. Accordingly, the aforementioned model should be modified or adjusted to give an acceptable position accuracy in order to qualify as a basis for distance estimation. For example, the electromagnetic wave transmitted from the base station to the portable device may attenuate due to shielding by the surrounding terrain such as buildings and parks such that the signal intensity detected by the portable device will be smaller than the predicted signal intensity. If the smaller signal intensity detected by the portable device is substituted into the above equation, the calculated distance will be erroneous and different from the actual distance.

Since the propagation of electromagnetic wave changes randomly in different environment, it is typically characterized by an electromagnetic wave propagation model instead of a precise mathematical equation. However, to meet theoretical research needs, conventional electromagnetic wave propagation models always consider so many factors that they have become too costly and too hard to implement in actual applications. In general, all of the positioning algorithms have some disadvantages as follows.

1. In order to reduce the error due to the propagation environment, the equation is typically modified according to conventional electromagnetic wave propagation models instead of the statistical measurement of the real environment. Hence, the feature database of the real environment has not yet been built.

2. Algorithm is tested with several simulation cases

The positioning algorithm is typically tested in a Gaussian-like-distribution noise environment which is designed to simulate a real environment. However, the real environment is not a Gaussian noise environment with uniform distribution. The Gaussian noise environment is just an approximate and ideal simulation.

3. Most of the environmental variables are determined from the actual test under a real environment. It works well theoretically but costs too much to implement in actual applications.

Accordingly, there is a need in the art for enhancing the accuracy of the Cellular Network positioning.

### SUMMARY OF THE INVENTION

The present invention provides a method for positioning a portable communication device by modifying the signal intensities detected by the portable communication device through environmental features from a geographic information system (GIS) thereby increasing the positioning accuracy.

The method of the present invention is suitable for use with a portable communication device. The method comprises the steps of (a) detecting signal intensities of a plurality of base stations near the portable communication device receiving radio waves from the base stations, and finding the coordinates of the base stations; (b) calculating a position coordinate of the portable communication device through the coordinates and the signal intensities of the base stations; (c) determining values of a plurality of values of the environmental features between at least one of the base stations and the portable communication device from a geographic information system (GIS) through said at least one coordinate of the base stations and the position coordinate of the portable communication device; (d) modifying the signal intensities of the base stations by substituting the values of environmental features into a path loss model; (e) recalculating the position coordinate of the portable communication device through the modified signal intensities of the base stations.

In one embodiment of the present invention, the step (a) comprises receiving identification data of each of the base stations thereby finding said at least one coordinate of the base stations through the identification data of the base stations. Additionally, the step (a) may comprise determining whether the number of the base stations is at least three. An error message is shown in response to a determination that the number of the base stations is fewer than three, and to indicate that the number is not sufficient to position the portable communication device. Additionally, step (a) may further comprise selecting three of the base stations having strongest signal intensities among the base stations, and positioning the portable communication device through the coordinates and signal intensities of the three selected base stations.

In one embodiment of the present invention, the step (b) may comprise the steps of establishing a set of equations based on the coordinates of the base stations and at least a distance between at least one of the base stations and the portable communication device, and solving the equations to calculate the position coordinate of the portable communication device. The above equations may be hyperbolic equations or circle equations.

In one embodiment of the present invention, the step (d) further comprises building the path loss model based on the mobile positioning characteristics regarding the locations of the base stations.

In one embodiment of the present invention, the method may further comprise the step of repeating the steps (c), (d) and (e) until times of calculation of the position coordinate have reached a predetermined number.

In one embodiment of the present invention, the above values of the environmental features comprise the heights of buildings, the density of buildings, the distances between two of the buildings, the widths of the streets and the orientations of the streets.

The present invention utilizes the environmental features between the base stations and the portable communication device from a geographic information system to modify the signal intensities. A modified position coordinate of the portable communication device is calculated through the signal intensities of the base stations. The modifying step is repeated to determine a more precise position coordinate thereby reducing error and enhancing the positioning accuracy.

The present invention further provides a method for positioning a portable communication device by modifying the position coordinate through a regional feature of the region where the portable communication device is located thereby increasing the positioning accuracy.

The present invention further provides a method for positioning a portable communication device using a service end device. The method comprises the steps of (a) receiving identification data and signal intensities of a plurality of base stations detected by the portable communication device; (b) determining a regional feature of a region where the portable communication device is located through the identification data and the signal intensities of the base stations; and (c) calculating a position coordinate of the portable communication device through the identification data and the signal intensities of the base stations, and modifying the position coordinate through the regional feature.

In one embodiment of the present invention, the regional feature determining step comprises the steps of determining a base station having a strongest signal intensity among the detected base stations, and taking a regional feature of a region where the base station having the strongest signal intensity is located, through the identification data of the base station, as the regional feature of the portable communication device. The above regional feature is determined from a regional feature database of the service end device.

In one embodiment of the present invention, the positioning step comprises establishing the regional feature database by the steps of dividing an environment into a plurality of regions according to the geographic characteristics of the environment from a geographic information system, gathering environmental information of a plurality of locations within at least one of the plurality of regions of the environment, and calculating a regional feature of said at least one of the plurality of regions through substituting the environmental information of the plurality of locations into an electromagnetic wave propagation model, and storing the regional feature of said at least one of the plurality of regions in the regional feature database. The aforementioned region may be exemplified as parks, suburban area, squares, residential building area and high building area. The environmental information of the locations may include the type and the height of the base station, and the distance between the portable communication device and the base station.

In one embodiment of the present invention, the step of calculating the position coordinate comprises the steps of calculating a distance between each of the base stations and the portable communication device through the signal intensities of the base stations and the regional feature of the portable communication device; determining a coordinate of each of the base stations through the identification data of each of the base stations; and calculating the position coordinate of the portable communication device according to the distance between each of the base stations and the portable communication device as well as the coordinate of each of the base stations.

In one embodiment of the present invention, the distance calculating step comprises substituting the signal intensities of the base stations and the regional feature of the portable communication device into an electromagnetic wave propagation model in order to calculate the distance between each of the base stations and the portable communication device.

Additionally, the position coordinate calculating step comprises establishing a set of equations through the coordinate of each of the base stations and the distance between each of the base stations and the portable communication device, and solving the equations to calculate the position coordinate of the portable communication device.

In one embodiment of the present invention, the above base stations detected by the portable communication device comprise at least three of the base stations. After receiving the identification data and signal intensities of the base stations are received by the service end device, three of the base stations having strongest signal intensities among the detected base stations are selected for positioning the portable communication device through the identification data and the signal intensities of the three selected base stations. The service end device transmits an error message to the portable communication device when the number of the detected base stations is fewer than three.

The method of the present invention comprises classifying the regions where the base stations are located and calculates the statistical regional features of the regions in advance. During positioning of the portable communication device, the region feature of the region where the device is located at the present time may be determined as the region feature of the region where the closest base station is located wherein the closest base station may be determined through the signal intensities of the surrounding base stations. A more precise position coordinate is calculated through modification based on the regional feature thereby diminishing the error.

The above and other objects, aspects and advantages of the present invention will become apparent from the following description of embodiments with reference to the accompanying drawings.

### BRIEF DESCRIPTION OF THE DRAWINGS

FIG. 1 shows the flow chart of a method for positioning a portable communication device according to one embodiment of the present invention;

FIG. 2 shows the flow chart of a method for positioning a portable communication device according to another embodiment of the present invention;

FIG. 3 shows the block diagram of a method for positioning a portable communication device according to another embodiment of the present invention;

FIG. 4 shows the flow chart of a method for positioning a portable communication device according to one embodiment of the present invention; and

FIG. 5 shows the flow chart of a method for positioning a portable communication device according to one embodiment of the present invention.

### DETAILED DESCRIPTION OF THE PREFERRED EMBODIMENT

Conventional positioning algorithms are typically performed without taking the environmental factors into consideration thereby increasing the positioning error. As a result, the present invention provides a method of raising the positioning accuracy by modifying the signal intensity of each of the base stations detected by the portable communication through the environmental features. The subject matter of the present invention will become apparent from the following description of embodiments.

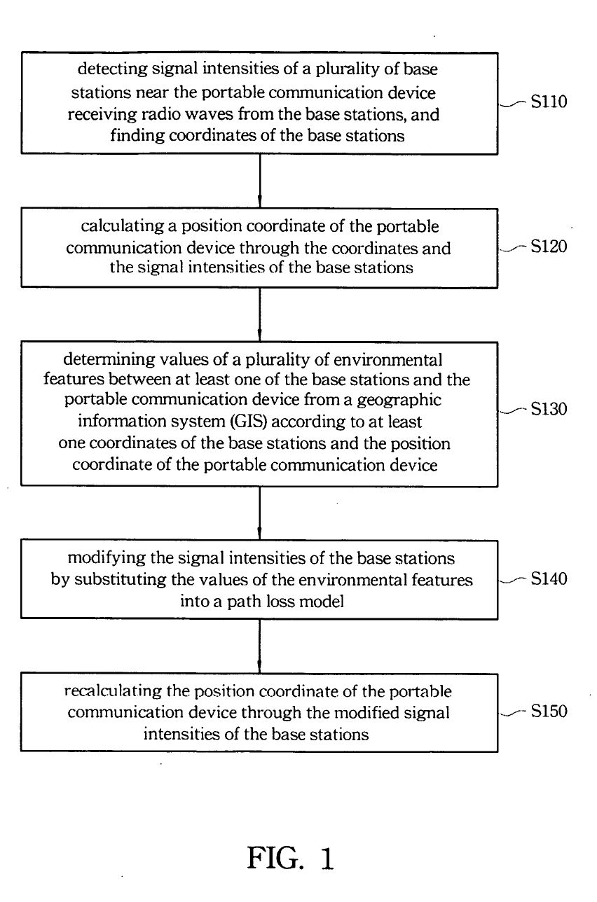

FIG. 1 shows the flow chart of a method for positioning a portable communication device according to one embodiment of the present invention. First, in the step S110, after receiving a positioning request, the portable communication device will detect the signal intensities of the surrounding base stations receiving radio waves from the base stations, and find the coordinates (e.g., longitude and latitude) of each of the base stations. Specifically, the coordinates are determined through the identification data of the base station which is received by the portable communication device during the detection of the signal intensities of the base stations near the portable communication device.

In other words, in case there are base stations A˜E disposed within the communication range of the portable communication device, the portable communication device will receive radio waves from the base stations A˜E and calculate the intensities of the received signal. Additionally, the base stations A˜E transmit their identification data (such as a set of digital numbers) to the portable communication device thereby identifying the base station's location. Subsequently, the portable communication device can determine the coordinate and the transmit frequency of each of the base stations through the identification data. It should be known to one skilled in the art that the term “a portable communication device” may refer to, but is not limited to, a mobile phone, a cordless phone, a portable radiotelephone device, a cell-phone, a cellular device and the like.

Next, in the step S110, the position coordinate of the portable communication device is calculated through the coordinates and the signal intensities of the base stations. Specifically, the coordinates and the signal intensities of the base stations are substituted into an electromagnetic wave propagation model to determine the distance between the portable communication device and each of the base stations. A set of equations, e.g., hyperbolic equations or circle equations, is established based on the coordinates of the base stations and the distance between each of the base stations and the portable communication device. Finally, the equations are solved for finding the positioning coordinate of the portable communication device.

Note that, theoretically at least three of the base stations are required to determine the location the portable communication device. The larger the number of the detected base stations is, the more accurate position coordinate can be calculated.

As shown in step S130, after calculating the position coordinate, the portable communication device determines a plurality of environmental features between at least one of the base stations and the portable communication device from a geographic information system (GIS) according to the coordinates of the base stations and the position coordinate of the portable communication device. The environmental features may comprise the heights of buildings, the density of buildings, the distance between two of the buildings, the street widths and the street orientation.

The electromagnetic wave attenuates along the propagation path, and the attenuation varies in different propagation environments. For example, the larger the number of the buildings between the base stations and the portable communication device is or the longer the distance between the base stations and the portable communication device is, the weaker the signal intensities received by the portable communication device. Therefore, in step S140, a specific path loss model is used to modify the signal intensities of the base stations detected by the portable communication device. Specifically, the portable communication device substitutes the values of the environmental features into the path loss model to modify the signal intensities of the base stations detected by the portable communication device.

It is worthy to mention that the establishment of the pass loss model considers the multiscreen diffraction loss of radio propagation and the shadow effect over multiple rooftop of the buildings. In this embodiment, the pass loss model is established based on the mobile positioning characteristics regarding the locations of the base stations, e.g., the density of the base stations, the communication range of the portable communication and the base stations. Given below is the detailed description regarding how to establish the pass loss model which is illustrated by using the Cost-231 Walfisch-Ikegami model defined by the following formula:

L=L₀+Lᵣₜₛ+Lₘₛ (1)

In formula (1), L is a total path loss used to modify a signal intensity of each of the base stations, L₀ represents free-space path loss resulting from a transmission path between antennas of at least one of the base stations and the portable communication device, Lᵣₜₛ represents building rooftop to street diffraction and scatter loss, wherein the radio waves propagate over buildings the portable communication device is located in a street, and Lₘₛ represents multiscreen diffraction loss of radio propagation over multiple rooftops of the buildings. L₀, Lᵣₜₛ and Lₘₛ are calculated as follows:

$$\begin{matrix}{L}_{0} = 32.4 + 20 log ( d ) + 20 log ( f ) & ( 2 ) \\ {L}_{rts} = 16.9 + 10 log ( w ) + 10 log ( f ) + 20 log ( {h}_{1} - {h}_{2} ) + {L}_{1} & ( 3 ) \\ {L}_{1} = \{ \begin{matrix}- 10 + 0.354 θ , & 0 < θ < 35 \\ 25 + 0.075 ( θ - 35 ) , & 35 < θ < 55 \\ 4 - 0.114 ( θ - 55 ) , & 55 < θ < 90\end{matrix} & ( 4 ) \\ {L}_{ms} = {L}_{1} + 54 + 18 log ( d ) + {K}_{1} log ( f ) + 9 log ( {d}_{1} ) & ( 5 ) \\ {K}_{1} = - 4.0 + 0.7 ( f / 925 - 1 ) & ( 6 )\end{matrix}$$

In the formulas (2)˜(6), d represents the distance between the portable communication device and the base station, f represents the transmit frequency of the base station, w represents the width of the street, h1 represents the height of building, h2 represents the height of base station, L1 represents a compensation for diffraction loss resulting from an angle θ between street orientation and the orientation of the electromagnetic waves diffracting to the ground, d1 represents a distance between two of the buildings between which the portable communication device is located, and K1 represents the density of buildings. As a result, the signal intensity of each of the base stations received by the portable communication device can be modified by substituting the values of environmental features between each of the base stations and the portable communication device into above formulas (1)˜(6).

Finally, in step S150, after modifying the signal intensities of the base stations, the position coordinate of the portable communication device is recalculated according to the modified signal intensity of each of the base stations. Specifically, the distance between each of the base stations and the portable communication device could be recalculated according to the modified signal intensity of each of the base stations and the base stations transmit frequency. Thereafter, a more precise position coordinate can be calculated according to the modified distance and the coordinate of each of the base stations.

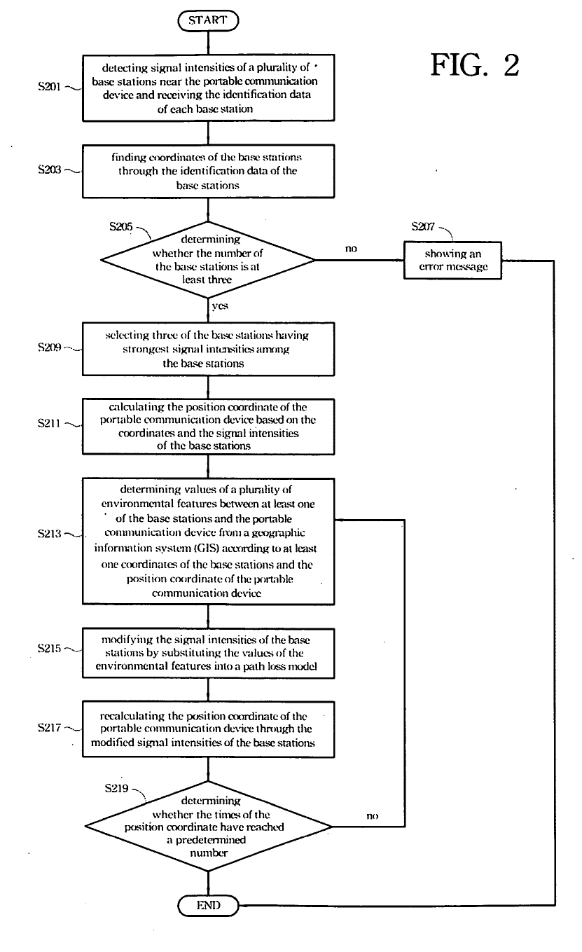

Given below is another embodiment to illustrate the positioning method of the present invention in details. FIG. 2 shows the flow chart of a method for positioning a portable communication device according to another embodiment of the present invention. Referring to FIG. 2, in step S201, the portable communication device detects the signal intensities of a plurality of base stations within the communication range of the portable communication device, and receives the identification data of the base stations.

Subsequently, in step S203, the portable communication device finds the coordinates and the transmit frequency of each of the base stations according to the identification data for proceeding the following calculation.

After that, in step S205, the portable communication device determines whether the number of base stations detected by the portable communication device is sufficient to position. Theoretically, positioning a predetermined point requires the coordinates of at least three other points and the distances between the predetermined point and those points such that the coordinate of the predetermined point can be calculated. Accordingly, in step S205, the position coordinate of the portable communication device is calculated through the coordinates of three of the base stations in response to a determination that the number of the base stations is at least three.

If the number of the base stations is fewer than three, it is determined that information is not sufficient for positioning, a step S207 is conducted to show an error message to notify the user indicating that the number of the detected base stations is not sufficient for positioning. On the contrary, if the number of the detected base stations is more than three, a step S209 is conducted. In the step S209, the portable communication device selects three of the base stations having strongest signal intensities among the base stations thereby positioning the portable communication device through the coordinates and the signal intensities of the three of the base stations. Three of the base stations, A, B and C are used to further illustrate the present invention.

In the case that the base stations A, B and C are the base stations having strongest signal intensities among the detected base stations, the portable communication device finds the coordinates (x_{A}, y_{A}), (x_{B}, y_{B}), (x_{C}, y_{C}) and the transmit frequency f_{A}, f_{B}, f_{C} of the base stations A, B and C according to the identification data of the base stations A, B and C, respectively.

Subsequently, in step S211, the position coordinate of the portable communication device is calculated based on the coordinates and the signal intensities of the base stations. Specifically, the signal intensities and the transmit frequency (L_{A}, f_{A}), (L_{B}, f_{B}), (L_{C}, f_{C}) of the three of the base stations are substituted into the electromagnetic wave propagation model thereby calculating the distances d_{A}, d_{B}, d_{C} between the portable communication device and the base stations A, B, C. After that, a set of equations is established based on the coordinates (x_{A}, y_{A}), (x_{B}, y_{B}), (x_{C}, y_{C}) of the base stations and the distances d_{A}, d_{B}, d_{C} between each of the base stations and the portable communication device. Finally, the equations are solved to calculate the position coordinate (x, y) of the portable communication device.

After the position coordinate (x, y) of the portable communication device is calculated, as shown in step S213, the environmental features between at least one of the base stations and the portable communication device can be determined from a geographic information system (GIS) through the coordinates (x_{A}, y_{A}), (x_{B}, y_{B}), (x_{C}, y_{C}) of the base stations and the position coordinate (x, y). For example, the environmental features between the base station A and the portable communication device may include the height of the buildings, a density of building, the distance between two of the buildings, the street width, the street orientation located between the coordinate (x_{A}, y_{A}) and the position coordinate (x, y). The environmental features regarding other base stations may be determined in the sane way and will not be described hereinafter in further detail.

In step S215, the values of environmental features are substituted into a path loss model such as Cost-231 Walfisch Ikegami model for modifying the signal intensities of the base stations A, B, C. Specifically, the values of environmental features between the base stations A, B, C and the portable communication device are substituted into the path loss model to determine the modified signal intensities L′_{A}, L′_{B}, L′_{C}.

In step S217, the position coordinate of the portable communication device is recalculated through the modified signal intensities L′_{A}, L′_{B}, L′_{C} of the base stations A, B, C. Specifically, the modified intensities L′_{A}, L′_{B}, L′_{C} of the base stations A, B, C are used to determined the distances d′_{A}, d′_{B}, d′_{C} between the portable communication device and the base stations A, B, C in the same way as described in step S211. After that, the modified position coordinate (x′, y′) of the portable communication device is calculated through the distances d′_{A}, d′_{B}, d′_{C} between the portable communication device and the coordinates (x_{A}, y_{A}), (x_{B}, y_{B}), (x_{C}, y_{C}) of the base stations A, B, C.

In order to further raise the accuracy of positioning, the steps S213, S215 and S217 are repeated until times of calculation of the position coordinate have reached a predetermined number thereby determining the most accurate position coordinate. Accordingly, in step S219, the portable communication device determines whether the times of calculation of the position coordinate have reached a predetermined number, e.g. five times. If the times have reached the predetermined number, the positioning process is terminated and the last one of modified position coordinates is took as the position coordinate of the portable communication device. If the times have not reached the predetermined number, the steps S213˜S219 are repeated until the times have reached the predetermined number. The number is predetermined depending on the user's requirement conditions and is not limited by the foregoing description.

By repeating the position coordinate modifying step, the position coordinate is modified to approximate the actual position coordinate of the portable communication thereby raising the positioning accuracy of the present invention.

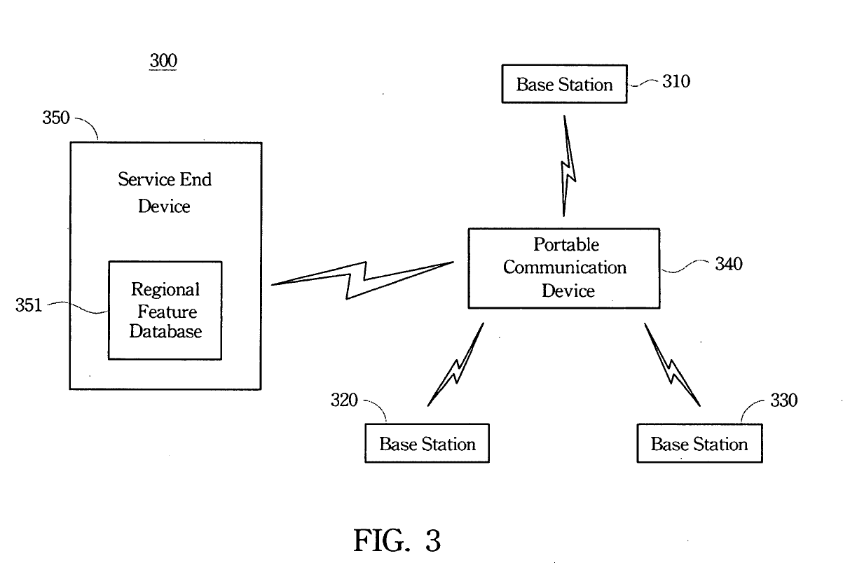

FIG. 3 shows the block diagram of a method for positioning a portable communication device according to another embodiment of the present invention. The positioning system 300 includes base stations 310, 320, 330, a portable communication device 340 and a service end device 350, wherein the service end device 350 includes a regional feature database. The regional feature database is used to store the regional features of various regions such as park, suburbs, residential buildings, high buildings and so forth. The portable communication device such as a mobile phone receives radio waves from the base stations 310, 320, 330 and finds the identification data of these base stations from the radio waves. The portable communication device 340 transmits the identification data and the signal intensities to the service end device 350 thereby allowing the service end device 350 to position the portable communication device 340.

Briefly, the service end device 350 determines the regional feature of a region where the portable communication device 340 is located through the identification data and the signal intensities and subsequently calculates the distances between each of the base stations 310, 320, 330 and the portable communication device 340 through the regional feature and the identification data and the signal intensities of the base stations 310, 320, 330, respectively. Next, the service end device 350 calculates the position coordinate of the portable communication device 340 through the coordinates (i.e., the longitudes and latitudes) of the base stations 310, 320, 330 and the distances and then transmits the position coordinate back to the portable communication device 340.

Note that at least three of the base stations are required to locate the portable communication device 340. The larger the number of the detected base stations is, the more accurate position coordinate can be calculated. Only three of the base stations are used to illustrate the present invention but the number of base stations is not limited to the specific embodiment illustrated below.

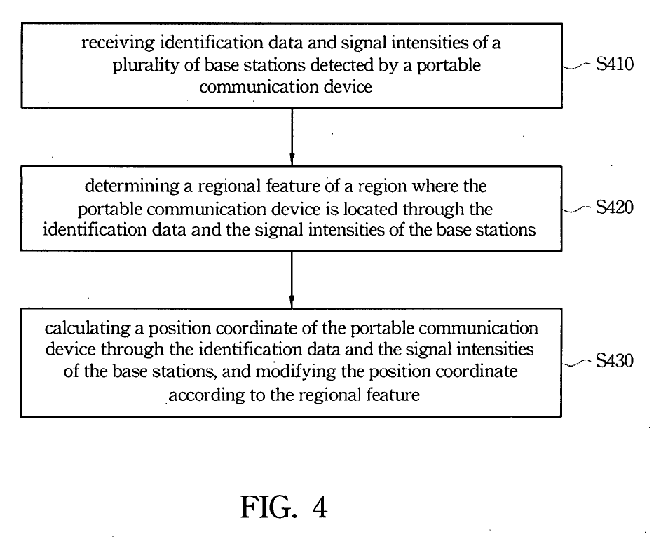

The method of the present invention is described in detail below in conjunction with the positioning system 300. FIG. 4 shows the flow chart of a method for positioning a portable communication device according to another embodiment of the present invention. Referring to FIG. 3 and FIG. 4, in step S410, the service end device 350 receives the identification data and the detected signal intensities of the base stations 310, 320, 330 from the portable communication device 340.

In practical application, the coordinate of the base stations 310, 320, 330 are registered at the service end device 350, e.g., at the regional feature database 351, and a set of identification data, e.g., a set of number code, is assigned to each of the base stations 310, 320, 330. Upon receiving a positioning request, the portable communication device 340 will detect the surrounding base stations 310, 320, 330, and the base stations 310, 320, 330 transmit the identification data to the portable communication device 340. After that, the portable communication device 340 transmits the identification data and the signal intensities of the base stations 310, 320, 330 to the service km end device 350. As a result, the service end device 350 can identify the base stations detected by the portable communication device 340 through the identification data.

In step S420, the service end device 350 determines a regional feature of a region where the portable communication device 340 is located through the identification data and the signal intensities of the base stations 310, 320, 330.

The electromagnetic wave attenuates during propagation and the attenuation varies in different propagation environments. For example, the more shielding objects between the base stations 310, 320, 330 and the portable communication device 340 exist, the weaker the signal intensities received by the portable communication device 340 are. Therefore, the service end device 350 has to determine which region the portable communication device 340 is located at in order to find the regional feature of the region.

The regional feature may be determined by the service end device 350 through determining the base station having strongest signal intensity among the base stations 310, 320, 330. For example, if the base station 310 is the one having strongest signal intensity, the service end device 350 can take the regional feature of the base station 310 as the regional feature of the portable communication device wherein the regional feature of the base station 310 is obtained from the regional feature database 351 through the identification data of the base station 310.

The foregoing regional features are stored in the regional feature database of the service end device 350. The base stations 310, 320, 330 are classified according to which region they are located at, and a set of number code is defined by the regional feature database for each region. That is to say, in the regional feature database 351, the identification data of the base stations 310, 320, 330 are corresponding to a set of coordinate and regional feature, respectively. Therefore, the service end device 350 may find the regional features of the base stations 310, 320, 330 through the identification data of the base stations 310, 320, 330, and then determine the regional feature of the region where the portable communication is located.

In practical application, the regional feature database 351 may be established in the service end device 350 according to the actual environment. Specifically, the database 351 may be established by dividing an environment into a plurality of regions, e.g. a park, suburban area, a square, residential buildings up to 10 floors and high-rise buildings (ten or more floors) according to the geographic characteristics from a geographic information system. The above regions are merely exemplary in nature and are not intended to limit the invention or the application and uses of the invention.

After the environment is divided into the regions, the environmental information (e.g., the type of base station (transmit frequency), the height of base station and the distances between the portable communication device 340 and the base stations 310, 320, 330) of a plurality of locations within each region is utilized to calculate the regional feature of each region by an electromagnetic wave propagation model such as Cost-231 model.

Specifically, the actual distance between the portable communication device 340 and each of the base stations (310, 320, 330) can be measured in advance, respectively, and utilized to predict the signal intensities of the base stations 310, 320, 330 received by the portable communication device 310. Thereafter, the regional feature of the region where the portable communication device 340 is located at the present time can be obtained according to the difference between the predicted and the actually received signal intensities of each of the base stations. Taking the Cost-231 model as an example, the original formula of the model is shown as below.

L=42.6+26 log(d)+20 log(f) (f1)

Since the attenuation of the signal varies in different propagation environment. Therefore, the above formula (f1) is redefined in this embodiment as below.

L=42.6+26 log(d)+20 log(f)+log(∂) (f2)

Wherein d represents the distance between the portable communication device 340 and each of the base stations (310, 320, 330), L represents the signal intensities of base stations 310, 320, 330 detected by the portable communication device 340, f represents the transmit frequency of the base stations 310, 320, 330, and ∂ represents the regional feature. Briefly, the theoretically attenuated signal intensity (i.e., 42.6+26 log(d)+20 log(f)) plus the regional feature (i.e., log(∂)) equals to the signal intensity L actually received by the portable communication device 140. Hence, the regional feature ∂ can be calculated by the formula (f2) having the regional feature ∂ as the only unknown.

Given below is an example of using the base station 310 to illustrate how to calculate the regional feature. When the signal transmits from the base station 310 to the portable communication device 340, the signal attenuates due to the environmental factors in the propagation path. As a result, if the actual signal intensity transmitted from the base station 310 to the portable communication device 340 can be determined, the regional feature can be calculated according to the difference caused by the environmental factors.

Based upon the measured linear distance between the portable communication device 340 and the foundation of the base station 310 as well as the height of the base station 310, the actual distance between the base station 310 and the portable communication device 340 can be calculated. Then, the signal intensity detected by the portable communication device 340, the transmit frequency of the base station 310 and the actual distance between the base station 310 and the portable communication device 310 are substituted into the formula (f2) such that the regional feature of the region where the base station 310 is located can be calculated. The above regional feature-calculating step is repeatedly performed with the portable communication device 340 being placed at different locations within the signal range of the base station 310. Thereafter, all of the regional features corresponding to various locations are subject to statistical calculations such as average thereby obtaining the regional feature of the region where the portable communication device 340 is located. The rest regional features may be deduced by analogy.

After obtaining the regional feature of the region where the portable communication device 340 is located, as shown in step S430, the service end device 150 calculates the position coordinate of the portable communication device 340 through the identification data and the signal intensities of the base stations 310, 320, 330, wherein the position coordinate is modified by the regional feature.

Specifically, the service end device 350 would calculate the distances between the portable communication device 340 and the base stations 310, 320, 330 respectively through the signal intensities of the base stations 310, 320, 330 and the regional feature of the portable communication device 340. Then, the coordinates of the base stations 310, 320, 330 are obtained through the identification data of the base stations 310, 320, 330. Thereafter, the service end device 350 can calculate the position coordinate of the portable communication device 340 according to the distance between the portable communication device 340 and the base stations 310, 320, 330.

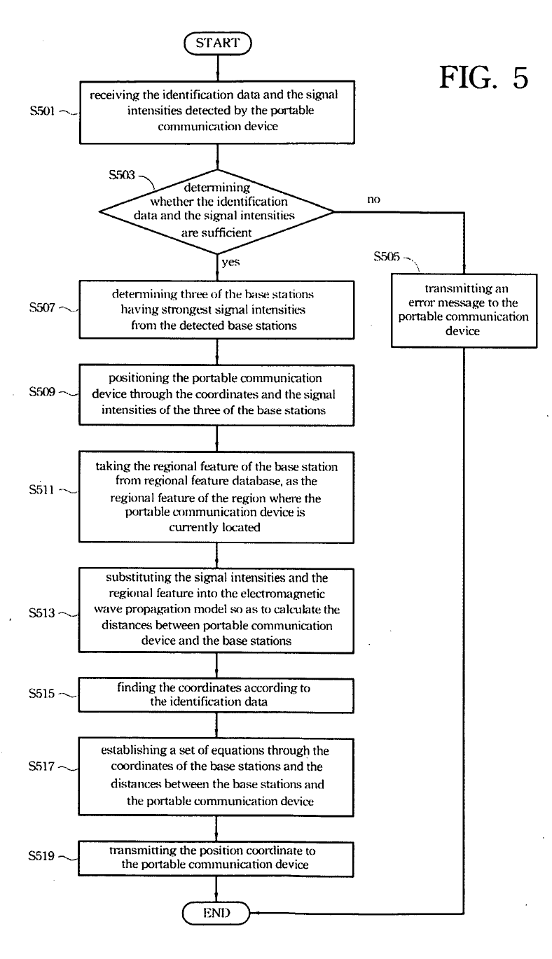

Given below is another embodiment to further illustrate the positioning method of the present invention in details. FIG. 5 shows the flow chart of a method for positioning a portable communication device according to one embodiment of the present invention. Referring to FIG. 3 and FIG. 5, in step S501, the service end device 350 receives the identification data ID₁, ID₂, ID₃ and the signal intensities L₁, L₂, L₃ detected by the portable communication device 340.

In step S503, the service end device 350 determines whether the identification data and the signal intensities are sufficient. Specifically, the location of a specific point can only be determined by having the coordinates of at least three surrounding points and the distances between the specific point and the three surrounding points. Therefore, in step S503, the service end device 350 determines whether at least three of the base stations are detected by the portable communication device 340 and calculate the position coordinate of the portable communication device 340 through the coordinates of the three of the base stations.

If the number of the base stations is fewer than three, it is determined that information is not sufficient for positioning, a step S505 is conducted by the service end device 350 to transmit an error message to the portable communication device 340 for notifying the user indicating that the number of the detected base stations is not sufficient for calculating the position coordinate of the portable communication device. On the contrary, if the number of the detected base stations is more than three, a step S507 is conducted to select three of the base stations having strongest signal intensities among the base stations thereby positioning the portable communication device through the coordinates and the signal intensities of the three of the base stations. Three of the base stations 310, 320, 330 are used to further illustrate the present invention. The base stations 310, 320, 330 are assumed to have strongest signal intensity wherein the detected signal intensities are L₁, L₂, L₃ and the identification data received by the service end device 350 are ID₁, ID₂, ID₃.

After that, in step S509, the service end device 350 determines a base station having strongest signal intensity among the above three of the base stations. The stronger signal intensity the predetermined base station has, the closer the portable communication device may get to the base station. Assumed that the base station 310 has the strongest signal intensity L₁.

Thereafter, in step S511, the service end device 350 takes the regional feature of the base station 310 from regional feature database 351, as the regional feature ∂ of the region where the portable communication device 340 is currently located.

After determining the region where the portable communication device 340 is located, the service end device 350, as shown in step S513, substitutes the signal intensities L₁, L₂, L₃ and the regional feature ∂, which is determined in step S511, into the electromagnetic wave propagation model so as to calculate the distances d₁, d₂, d₃ between portable communication device 340 and the base stations 310, 320, 330. Specifically, the service end device 350 finds the transmit frequency f₁, f₂, f₃ of the base stations 310, 320, 330 through the identification data ID₁, ID₂, ID₃. Then, the service end device 350 substitutes (L₁, f₁, ∂), (L₂, f₂, ∂), (L₃, f₃, ∂) into formula (2) respectively for calculating the distances d1, d2, d3 between portable communication device 340 and the base stations 310, 320, 330.

Then, in step S515, the service end device 350 finds the coordinates (x₁,y₁), (x₂,y₂), (x₃,y₃) through the identification data ID₁, ID₂, ID₃. Because the identification data ID₁, ID₂, ID₃ and the coordinates (x₁,y₁), (x₂,y₂), (x₃,y₃) of the base stations are registered at the service end device 350 as the base stations 310, 320, 330 are mounted, the coordinates of the base stations can be found through the identification data.

After that, in step S517, the service end device 350 establishes a set of equations (as shown below) through the coordinates (x₁,y₁), (x₂,y₂), (x₃,y₃) of the base stations 310, 320, 330 and the distances d1, d2, d3 between each of the base stations and the portable communication device. The position coordinate (x, y) of the portable communication device 340 can be determined by solving the set of equations.

$$\{ \begin{matrix}{( {x}_{1} - x )}^{2} + {( {y}_{1} - y )}^{2} = {d}_{1}^{2} \\ {( {x}_{2} - x )}^{2} + {( {y}_{2} - y )}^{2} = {d}_{2}^{2} \\ {( {x}_{3} - x )}^{2} + {( {y}_{3} - y )}^{2} = {d}_{3}^{2}\end{matrix} \qquad ( 3 f )$$

After solving the equation (3f), the service end device 350 can determine the position coordinate (x, y) of the portable communication device 340.

Finally, in step S519, the service end device 350 transmits the position coordinate (x, y) to the portable communication device 340 thereby completing the whole positioning process.

To sum up, the method for positioning the portable communication device of the present invention has the advantages as follows:

1. The position coordinate is modified through the regional feature between the portable communication and each of the base stations thereby diminishing the error and raising the accuracy of positioning.

2. The method finds credible regional feature from an existing geographic information system without performing the field-testing thereby reducing the cost and expense.

3. An accurate position coordinate can be determined without complicated calculations such that the present invention can be implemented in actual applications.

4. According to the statistical measurement of the real environment, the regional features of different regions are obtained for establishing a regional feature database corresponding to the real situation such that the statistical measurement is obtained close to real situation.

While the invention has been described by way of example and in terms of the preferred embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for positioning a portable communication device comprising the steps of:
(a) detecting signal intensities of a plurality of base stations near the portable communication device receiving radio waves from the base stations, and finding coordinate of the base stations;
(b) calculating a position coordinate of the portable communication device through the coordinates and the signal intensities of the base stations;
(c) determining values of a plurality of environmental features between at least one of the base stations and the portable communication device from a geographic information system (GIS) according to said at least one coordinate of the base stations and tie position coordinate of the portable communication device;
(d) modifying the signal intensities of the base stations by substituting the values of the environmental features into a path loss model; and
(e) recalculating the position coordinate of the portable communication device through the modified signal intensities of the base stations.

2. The method of claim 1, further comprising the step of:
repeating the steps (c), (d) and (e) until times of calculation of the position coordinate have reached a predetermined number.

3. The method of claim 1, further comprising the steps of:
selecting three of the base stations having strongest signal intensities among the base stations; and
positioning the portable communication device through the coordinates and signal intensities of the three selected base stations.

4. The method of claim 1, wherein the step (a) further comprises:
determining whether the number of the base stations is at least three; and
in response to a determination that the number of the base stations is fewer than three, showing an error message to indicate that the number is not sufficient to position the portable communication device.

5. The method of claim 1, wherein the step (b) further comprises:
establishing a set of equations based on said at least one coordinate of the base stations and at least a distance between at least one of the base stations and the portable communication device; and
solving the equations to obtain the position coordinate of the portable communication device.

6. The method of claim 1, further comprising the step of building the path loss model based on the mobile positioning characteristics regarding the locations of the base stations.

7. The method of claim 1, wherein the path loss model is a Walfisch-Ikegami model defined by the following formula:
L=L₀+Lᵣₜₛ+Lₘₛ;
wherein L is a total path loss used to modify a signal intensity of each of the base stations; L₀ represents free-space path loss resulting from a transmission path between antennas of at least one of the base stations and the portable communication device; Lᵣₜₛ represents building rooftop to street diffraction and scatter loss, wherein the radio waves propagate over buildings the portable communication device is located in a street; and Lₘₛ represents multiscreen diffraction loss of radio propagation over multiple rooftops of the buildings.

8. The method of claim 7, wherein the multiscreen diffraction loss is defined by the following formula:
Lₘₛ=L₁+54+18 log(d)+K₁ log(f)+9 log(d₁);
wherein d represents a distance between the portable communication device and said at least one of the base stations, d₁ represents a distance between two of the buildings between which the portable communication device is located, K₁ represents a density of the buildings, L₁ represents a compensation for diffraction loss resulting from an angle θ between street orientation and a wave incidence coming from at least one of the base stations, and f represents a transmission signal frequency of each of the base stations.

9. The method of claim 1, wherein the step (a) further comprises:
detecting the signal intensities of the base stations and receiving identification data of the base stations; and
finding the coordinates of the base stations through the identification data of the base stations.

10. A method for positioning a portable communication device using a service end device, the method comprising the steps of:
(a) receiving identification data and signal intensities of a plurality of base stations detected by the portable communication device;
(b) determining a regional feature of a region where the portable communication device is located through the identification data and the signal intensities of the base stations; and
(c) calculating a position coordinate of the portable communication device according to the identification data and the signal intensities of the base stations, and modifying the position coordinate through the regional feature.

11. The method of claim 10, further comprising the step of transmitting the position coordinate to the portable communication device.

12. The method of claim 10, wherein the step (b) comprises the steps of:
determining a base station having a strongest signal intensity among the detected base stations; and
taking a regional feature of a region where the base station having the strongest signal intensity is located, according to the identification data of the base station, as the regional feature of the portable communication device.

13. The method of claim 10, wherein the regional feature is determined from a regional feature database of the service end device.

14. The method of claim 13, further comprising the step of establishing the regional feature database.

15. The method of claim 14, wherein the step of establishing the regional feature database comprises the steps of:
dividing an environment into a plurality of regions according to the geographic characteristics of the environment from a geographic information system;
gathering environmental information of a plurality of locations within at least one of the plurality of regions of the environment; and
calculating a regional feature of said at least one of the plurality of regions through substituting the environmental information of the plurality of locations into an electromagnetic wave propagation model, and storing the regional feature of said at least one of the plurality of regions in the regional feature database.

16. The method of claim 10, wherein the step of calculating the position coordinate comprises the steps of:
calculating a distance between each of the base stations and the portable communication device through the signal intensities of the base stations and the regional feature of the portable communication device;
finding a coordinate of each of the base stations through the identification data of each of the base stations; and
calculating the position coordinate of the portable communication device according to the distance between each of the base stations and the portable communication device as well as the coordinate of each of the base stations.

17. The method of claim 16, wherein the distance calculating step comprises the step of substituting the signal intensities of the base stations and the regional feature of the portable communication device into a electromagnetic wave propagation model in order to calculate the distance between each of the base stations and the portable communication device.

18. The method of claim 16, wherein the step of calculating the position coordinate of the portable communication device according to the distance between each of the base stations and the portable communication device as well as the coordinate of each of the base stations comprises:
establishing a set of equations through the coordinate of each of the base stations and the distance between each of the base stations and the portable communication device; and
solving the equations to determine the position coordinate of the portable communication device.

19. The method of claim 10, further comprising:
selecting three of the base stations having strongest signal intensities among the detected base stations, for positioning the portable communication device through the identification data and the signal intensities of the three selected base stations.

20. The method of claim 10, further comprising:
determining whether the number of the detected base stations is at least three; and
showing an error message indicating there is not sufficient information to calculate the position coordinate of the portable communication device, in response to a determination that the number of the detected base stations is fewer than three.
